(19) United States
(12) Patent Application Publication
(10) Pub. No.: US 2013/0227017 A1
(43) Pub. Date: Aug. 29, 2013

(54) LOCATION ASSOCIATED VIRTUAL INTERACTION, VIRTUAL NETWORKING AND VIRTUAL DATA MANAGEMENT

(71) Applicant: Steven Antony Gahlings, Cambridgeshire (GB)

(72) Inventor: Steven Antony Gahlings, Cambridgeshire (GB)

(21) Appl. No.: 13/776,283

(22) Filed: Feb. 25, 2013

Related U.S. Application Data
(60) Provisional application No. 61/602,906, filed on Feb. 24, 2012.

(51) Int. Cl. H04L 12/58

(52) U.S. Cl. CPC H04L 51/04
USPC 709/204

(57) ABSTRACT

Systems and methods for social and data communication that uses physical locations are disclosed. Tagging the data and/or communications to real locations provides that the data is given relevance/context by the tagged location and the data can be searched for/identified by other users using the physical location. By providing/updating the data in real-time, occurrences/interactions in the real world may be mirrored and or enhanced in the virtual world as they occur. Use of location tagging of the data provides for dissemination and/or identification of data by persons who are not “friends” or followers” of the party posting/uploading the data.

This application claims the benefit of and is a non-provisional of U.S. Application Ser. No. 61/602,906 filed on Feb. 24, 2012, which is incorporated by reference in its entirety for all purposes.

### BACKGROUND

Social networking over the Internet is a developing field that is growing and improving because of higher data communication rates, better wireless access to networks, wider distribution of smart phones. As the sophistication of social networking technologies is developing, there are still some aspects of the technology that remain rooted in the birth of internet social networking. Among other things, in general, social networking communications are channeled so that social network users communicate via lists of friends, through chat rooms, by following people or subjects.

### BRIEF SUMMARY

Embodiments of the present invention provide for location based social networking. Embodiments of the present invention provide for communicating and accessing data using real, physical location data.

In an embodiment of then present invention, data is received from a user of the location based social networking service. Location data is also received from the user, wherein the location data identifies a real, physical location. The location data may comprise a location of the user or a location selected by the user. The received data is tagged to a location associated with the location data. For example, the associated location may be the physical location of a landmark, building, business proximal to the location and/or a virtual location of an interaction location associated with the location data. In an embodiment of the present invention, the received data is made available to end-users from the tagged location, wherein an end-user viewing/searching a virtual representation of a location/view including the tagged location will see/find the data tagged to the tagged location on the virtual representation.

In an embodiment of the present invention, an end user may respond to the data and the responsive data will be tagged to the original data. In embodiments of the present invention users may communicate and exchange data using location as a data storage and search parameter.

In embodiments of the present invention, by making the receipt and communication of the data occur in real time, a virtual representation of a real location is provided that changes with the location and may be viewed searched so as to determine conditions at the real location.

In some embodiments filters may be used to restrict access to the data. The filters may provide for limiting access top people at the tagged location, people in an organization and/or the like. In some embodiments, the data is only available from the tagged location for a defined period of time.

### BRIEF DESCRIPTION OF THE DRAWINGS

The present disclosure is described in conjunction with the appended figures:

FIG. 1A is a flow-type illustration of a method for location based social networking, in accordance with one embodiment of the present invention

FIG. 1B is a flow-type illustration of a method for location based social networking, in accordance with one embodiment of the present invention;

FIG. 2 is a schematic-type illustration of a system for location based social networking, in accordance with one embodiment of the present invention;

FIG. 3A is an illustration of a virtual horizon of a location based social network, in accordance with an embodiment t of the present invention; and

FIGS. 3B & 3C are illustrations of virtual map-type representations for a location based social network, in accordance with an embodiment t of the present invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments maybe practiced without all the specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Information/data is constantly being requested and communicated on the Internet. Information is in general stored on Web Pages or the like and accessed by users who either know about the properties of a Web Page or find the Web Page via a search engine or the like. More and more, people are accessing the Internet using mobile devices such as smart-phones, tablets, notebooks, laptops and/or the like. Moreover, the Internet has become a place where people develop social networks by linking to people they know over the Internet, publishing details about themselves on social network sites and communicating thoughts/communications to linked friends or by sending out messages that can be found by other Internet users by way of the subject matter of the message and/or characteristics of the person sending the information.

While an unimaginable amount of data is available on the Internet and the number of people accessing/using and socializing on the Internet has grown exponentially, social networking, communicating and data storage and retrieval on the Internet is still very often a case of knowing where and how to gather information and knowing in the real world the person you are socializing with. The storage and retrieval of data on the Internet and the social communication on the Internet tends to follow pipelines and is not intuitive/consistent with how things are done in the real world. Moreover, in general, there is a dividing line between the real and virtual worlds that prevents a person from having virtual/real experiences, i.e., the combined experience of both the real and virtual world.

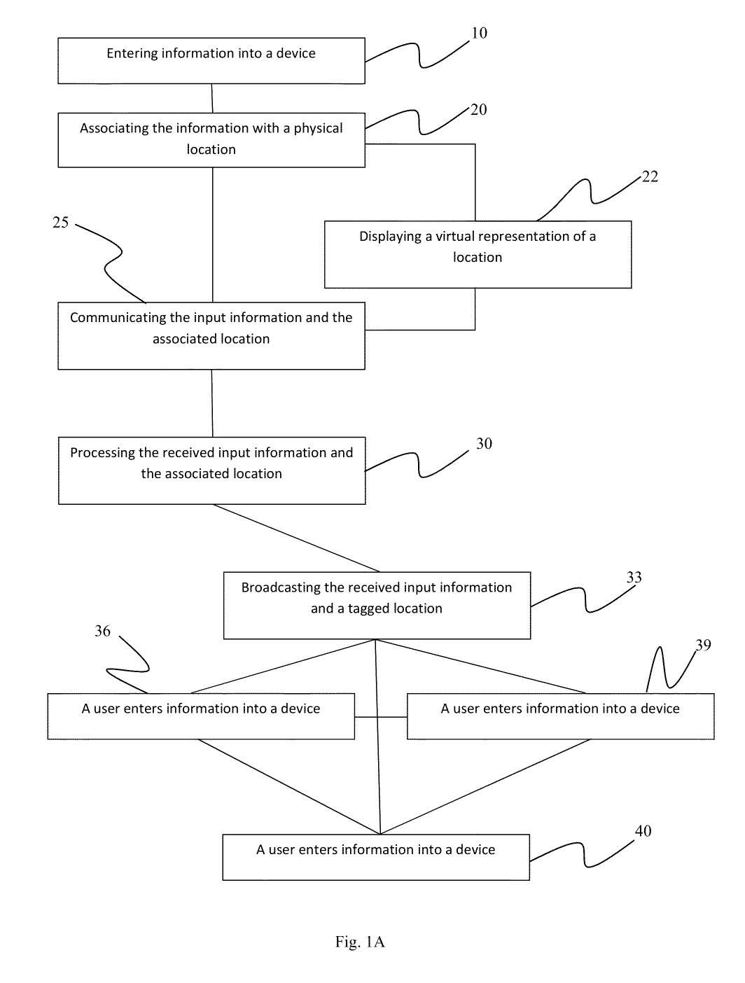

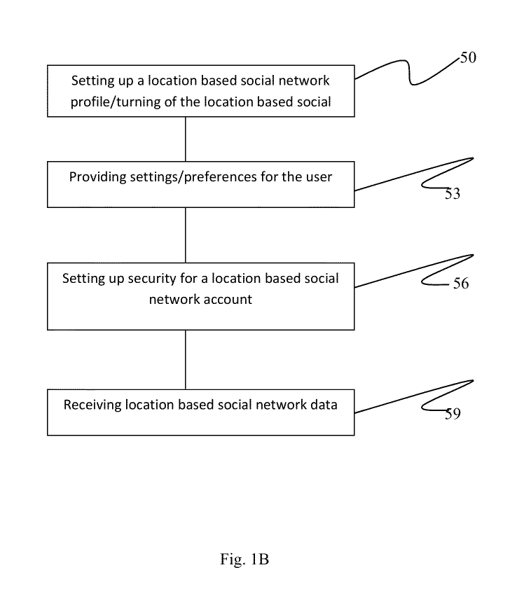

FIG. 1A is a flow-type illustration of a method for location based social networking, in accordance with one embodiment of the present invention. In step 10 a person enters information into a device. The device may be a mobile device such as a smartphone, a tablet, a laptop computer or the like. In some aspects the device may be a processor. The person may enter a communication, data, a hyperlink, a picture, a recording, a video and/or the like into the device. The device may be programmed to add an identifier to the information such as an avatar, a name, a link to a social profile of the user and/or the like.

In step 20 the information/data input by the user is associated with a physical location. The device may include software, a global positioning system and/or the like that may determine a real/physical location of the device. In some embodiments, when user generates the information on the device or attaches information such as a link, a picture, a social network profile and/or the like for communication, the device may associate the information with the current physical location of the device. In other aspects, the user may enter the physical location to be associated with the information. For example, a user may select a location on a virtual representation of a physical location to associate with the input information. The virtual representation may be a map, a street view, a virtual depiction of a horizon, a virtual depiction of the horizon/location at which the user is positioned and/or the like. The user may use a cursor or the like and move it over the virtual representation to determine the location to be associated with the input information. In other aspects, the user may enter an identifier for the location into the device,

In some aspects of the present invention, the device may store at least partially virtual representations of physical locations. In other aspects, virtual representations of real/physical locations may at least in part be communicated over a network to a user. In some aspects, the virtual representations may in part be stored on the device and in part be communicated to the device over the network by a service provider or the like.

In step 22, a virtual representation may be displayed to the user on the device. As noted above, the virtual representation of the location may comprise a picture of the location, a map of the location, a virtual illustration representing the location or the like. The user may request the virtual representation on the device by entering an identifier for a real physical location into the device. The user may use a geographical search tool to zoom in and/or out of topographical type geographical representations to identify locations of interest, such as are available in Internet map searches and the like. The user may use an identifier for a location and search for the location. In some aspects, the device may provide a virtual representation of the location where the user is situated. For example, the device may provide virtual horizons of views around where the user is situated, i.e., the device may show birds-eye views of the users location and horizon views for the views around the point where the user is located.

In some aspects, the user may select a location on the virtual representation to associate with the input information. In some aspects, interaction points may be displayed on the virtual representation and the use may select one of these interaction points to associate with the input information. For example, businesses, landmarks or the like may be associated with an interaction point, a specific location on the virtual representation and/or the like so that input information can be associated with a specific business, landmark r the like by associating the information with the interaction point, identified location on the virtual representation.

In step 25, the input information and the associated location information is communicated by the device over a network to a service provider. The service provider may be a provider of the social location networking service, a network provider and/or a provider associated with such a service provider and/or the like.

In step 30 the received input information and the associated location are processed. Processing may involve categorizing/characterizing the input information. Categories may include for example, comment, social communication, travel information, descriptive information, warning, hazard, historical information, geographical information and/or the like. In some aspects, the user submitting the input information may provide a characterization for the input information. Processing may also provide for tagging the input information to a physical location. For example, where the input information is associated with an actual location of the user inputting the information, i.e., a GPS or the like position of the device being used by the user, the input information may be tagged to the GPS identified physical location, a building/landmark in the vicinity of the GPS location, an interaction point near to the GPS location and/or the like. Where the user identifies a physical location, a landmark, an interaction point and/or the like with the input information, the input information will be tagged to this location.

In step 33 the received input information and the tagged location is broadcast. Broadcasting may mean communicating over a network. In some aspects the received input information and the tagged location is broadcast over the network to users of a location based social networking service. Broadcasting may comprise communicating a virtual representation of the location and the input information tagged to the virtual representation of the location. In other aspects, the input information may be communicated to the users along with an identifier of the tagged location so that a user's device may tag the input information to a virtual representation of the location. In other aspects, the input information may be communicated with a partial virtual representation of the location for assembly on a user's device.

In one embodiment, the entering of the input information and the broadcasting of the input information is carried out in real-time. In such an embodiment, the location based social networking system provides a system wherein users can communicate with one another and identify who is at a location, what is happening at a location and/or the like in real-time. In this way, the virtual horizons/representations broadcast to users provide a real-time virtual representation of the physical location.

As provided in more detail below, the virtual representation of the location may comprise a map, a picture of the location, an electronic representation of the location, a view of a horizon from the location and/or the like. The input information may be configured to be displayed on the virtual representation of the location as a bubble, as a symbol, as a link and/or the like so that a user receiving the input information can view the input information on the virtual representation of the location and/or can click on a symbol or the like to open the input information. In some aspects of the present invention, different symbols or the like may be used to identify the type of input information. This may provide a user with the ability to identify/select the type of information to be viewed.

In step 36, a filter may be applied to the users who may receive the broadcast input information. For example, the user that input the input information may provide instructions that the input information is only to be broadcast to: a list of friends identified by the user, a group of people such as members of an organization or the like; users with certain characteristics identified in the user's profile; users within a certain vicinity of the tagged location and/or the like. In this way, the user inputting the information may provide some rules as to who will be able to receive/view the input information.

In step 39, broadcast parameters may be applied to the input information. For example, the input information may only be communicated to users within a certain distance of the location to which the input information is tagged. In other examples, a time-duration may be provided regarding how long the input information will be broadcast. For example, a comment may only be broadcast for a matter of minutes so that the comments being broadcast are changing with time and address current conditions/occurrences at the tagged location.

In step 40 a user may acquire the input information. Acquisition may comprise the user turning on access to/accessing the location based social networking system and viewing a virtual representation on a device of the locations/horizons/surroundings that are around or at the location of the user. For example, in a map view, the user may view locations surrounding the user's location and see/access input information tagged to the map. In other embodiments, the user may view horizons visible from the user's location and see input information tagged to the horizons. In some embodiments, the user's device may comprise a GPS system or the like and may display virtual representation of the user's location with input information tagged to the virtual representations. In one embodiment, the user's device may comprise a GPS system or the like and a gyroscope or the like so that the device may be able to process the user's location and a direction the device is pointing. In such an embodiment, the device may display a virtual representation of the horizon viewable from the device as located and oriented to the user with input information tagged to the virtual horizon. A user may be able to view a physical location and also view a virtual representation of the physical location with input information tagged thereto.

In some embodiments, the user may use location identifiers to pull up a virtual representation of a location to view the input information tagged to the location. For example, the user may search for a landmark/business/physical location through a search engine or the like and then view a virtual representation of the searched for location with input information tagged thereto. In other aspects, the user may use mapping software to find locations and access virtual representation with tagged input information from a map or the like. The user may provide filters for the types of tagged input information to be displayed. For example the user may filter tagged information so only social information is displayed to the user. The user may filter the tagged information so only information from friends, certain organization or the like is displayed to the user. The user may filter the broadcast information so only hazards are displayed. Filtering may provide that the user only sees broadcast information concerning restaurants, places of interest, business, clothes shops and/or the like. In one embodiment, a user may select a route on a map and view broadcast information tagged to locations along the route. Merely by way of example, the user may identify/select/create a route and filter broadcast information so that only tagged information concerning hazards, driving conditions and/or the like are displayed.

In step 43, a user may respond to input information. For example the user may respond to a social comment tagged tom a location. In some aspects, the response may be received by a service provider and broadcast to users in combination with the original input information. In this way, virtual conversations may be created. Because the location based social networking system may be configured to operate in real-time the virtual conversations may occur in real-time. For example, a user of the location based social networking system may not only see current reviews of businesses that are tagged to the businesses location, but the user may also be able to interact with the reviewers to obtain more information.

FIG. 1B is a flow-type illustration of a method for location based social networking, in accordance with one embodiment of the present invention. In step 50 a user sets up a location based social network profile. The user may provide information to a service provider providing the location based social networking service. The user information may comprise an avatar, a profile, a link, a user identifier and/or the like that may be displayed with data uploaded to the location based social network service by the user.

In embodiments of the present invention the user may need to turn on the location based social network. For example, a user may enter credentials to provide that the user's device communicates its location to a location based social network service provider and receives user data associated with the location of the device. Similarly, a user may have to connect their profile to the location based social network in order to search for data tagged to locations. This turning on of the location based social network, means that information concerning the user is communicated to the service provider and the service provider can manage the data accessed by the user.

For example the user may generate a social network profile that may be accessible to other users of the location based social network when the user submits data to the location based social network site. The user may provide a link to other social network sites so that other users may view the linked data via the data uploaded to the location based social networking site. In this way, the location based social network may provide for social networking via the location based communications.

In step 56, the user may set up settings/preferences for the location based social networking accounts. For example the user may identify a list of friends or the like, identify organizations, groups of people, companies, academic institutions, associations and/or the like. The user may then use one or more of the identified groupings to filter communication of data over the location based social network. For example, the user may provide that data tagged to a location is only communicated to one or more of the identified groupings.

In some aspects the groupings provided by the user may be verified. For example, organizations etc. may provide the location based social network provider with lists of members and or may be contacted to verify that a user is a member of the organization.

In step 56 security settings may be set for a location based social network account. In some embodiments, a user may provide a password and an identity of a device. In such embodiments, communications with the location based social network by the user will only be approved and data will only be uploaded if the user identity, password and device identification agree. In some aspects of the present invention, a user may identify one or more safe locations from which the account settings may be changed. This provides a location based security aspect to the location based social network. For example, the user may specify a real location associated with the user as a safe location. The user may then only change aspects of their account when they are using a device that is physically located at the safe location. Safe location security may be used in combination with one or more other security provisions.

In some aspects, location data from the location based social network may be used as a security check with respect to other Internet transactions. For example, a location of a transaction may be checked against a location of a user on the location based social network to determine if a transaction is genuine. Safe locations may be transmitted from the location based social network to other Internet transactions to provide verification of a transaction.

In step 59 a user of the location based social network may receive information tagged to a location. The user preferences may be applied as a filter so only data uploaded by people in one of the listed groupings is received by the user. In some aspects the user may simply view a display of his or her device to view the data tagged to the location of the user or the surroundings. For example, the user may view a birds-eye view of the location of the user and see data tagged to the location or the proximal locations. In some aspects the device may be fitted with GPS or the like so that the device may communicate its location to the location based social network and the location based social network may communicate the data tagged to the devices location. In some aspects the device may comprise a GPS or the like and a gyroscope or the like so that the device is able to determine its location and orientation. In such aspects the device may display a virtual representation of the horizon viewed from the device at its location and orientation with data tagged to businesses, buildings, landmarks, location on the virtual representation of the horizon. In this way, a user may be able to move the device around and view a virtual horizon corresponding to the actual horizon in from of the user. In embodiments where the location based social network receives, tags and broadcasts user data in real-time, the user can view occurrences on the virtual horizon in real-time. This real-time updating provides for the user being able to communicate with people in his vicinity, obtain information about the location and occurrences at the location in real-time.

In some embodiments, the user may retrieve/access tagged user data by identifying a real location and receiving data tagged to the real location from the location based social network. The user may use a search engine associated with the location based social network to select a location and then retrieve data tagged to the location. In other aspects the user may use a map view to identify a real location and then view the map, a virtual representation of a location identified on the map or the like to access data tagged to the location. The virtual representation of the location may be a map, a photograph of the location, an electronic representation of the location and/or the like. The data tagged to the location may be displayed in a bubble attached to the virtual representation, may comprise a hyperlink attached to the virtual representation, may comprise a symbol or the like attached to the virtual representation and/or the like.

In aspects of the present invention the user may set up filters to filter information displayed to the user. The filters may filter the type of data to be displayed. For example, the user may only wish to see social communications, historical data, geographical data, hazard/warning data, traffic data, business data, reviews and/or the like. In one embodiment, the user may identify/select a route on a map or the like and may retrieve data tagged to locations along the route and/or proximal to the route. In this way, the user may, in real-time determine what is happening on a proposed route, i.e. may identify hazards, traffic congestions, social events and/or the like taking place along a route. In some aspects, a user may select a business or a landmark and see what occurrences are happening at the business or landmark. Merely, by way of example, a user may be able to view reviews of events, services as they occur. Moreover, the user can access these real-time reviews using only location data. As noted above, filters may be applied so that a user only receives data tagged to locations proximal to the user. In this way, locational boundaries may be put around the social interactions.

In some embodiments, the user may respond to tagged data by identifying the data and sending a response to the location based social network service provider. When received the service provider may tag the response to the identified data so that an interaction can take place in real time and be viewed at a virtual representation of the location the data is tagged to. In this way, users may use location as a basis for generating interactions. Moreover, users outside of the location and its environs may be able to view a transaction using location and/or determine what is occurring at a location based upon the interactions. Because of the real-time nature of some embodiments, users may be able to view a real time, virtual representation of a location and determine what is happening at the location in real time. Moreover, users who do not know names/identities of businesses, landmarks proximal to their location may ask questions and or view other user's real time data to determine the identity of businesses or the like, the services they are providing at that time and even a real-time review of the service. By limiting locational scope of access to tagged data, virtual occurrences may be generated at location. Moreover, by giving tagged data a limited access duration, experiences may be shared securely.

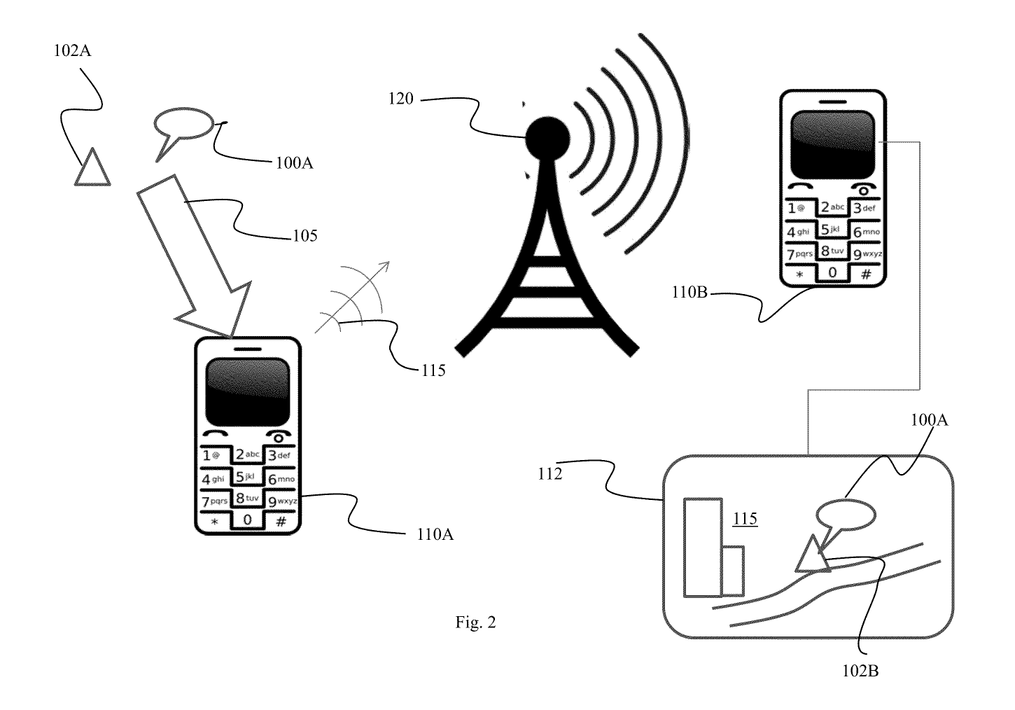

FIG. 2 is a schematic-type illustration of a system for location based social networking, in accordance with one embodiment of the present invention. A user of location based social network may generate data 100A and enter the data 100A into a device 110A. The device may be a smartphone, a processor, a laptop, a tablet and/or the like. The data 100A may be associated with a real, physical location 102A. The real physical location may be the location of the device 110A or may be a real location selected by the user. For example, the user may view a virtual representation of locations, such as a map, a street view, an electronic representation of locations and/or the like and may select the location to which the data 100A is to be tagged.

The device 110A may communicate the data 100A and the associated location 102A over a network 115 to a service provider (not shown). The network may comprise the Internet, an intranet, a wireless network and/or the like. The service provider may comprise the location based social network service provider, an associated service provider, a network provider and/or the like.

The service provider may receive the data 100A and the associated location 102A and tag the data 100A to a tagged location. The location may be the associated location 102A or it may be a location proximal to the associated location 102A. For example, where a business, landmark and/or interaction point is proximal to the associated location 102A, the service provider may tag the data 100A to the business, landmark and/or interaction point. An interaction point may be a location that is set up for location based social networking, for example a business or the like may set up a location where users of the location based social network may post and view data preventing data being tagged to several different physical locations associated with the business/landmark.

The service provider may broadcast 120 the data 100A and the tagged location to users. The term broadcast may mean communicating the data to the users. The data 100A and the tagged location may be broadcast 120 over the Internet, an intranet, a wireless network and/or the like. In embodiments of the present invention the data 100A and the associated location 102A may be received by the service provider and the data 100A and the tagged location broadcast by the service provider in real time.

The data 100A and the tagged location may be broadcast to only a certain set of users. For example, in some aspects the data 100A and the tagged location may only be broadcast to users within a certain distance of the associated location 102A and/or the tagged location. In some aspects, the data 100A will only be displayed for determined period of time. For example, in some aspects, social data, hazards, data concerning occurrences, hazards, traffic conditions and/or the like may be displayed for a matter of minutes. This may help maintain the real-time nature of the location based social network and prevent the data becoming stale and/or cluttering the location. Some of the data 100A, such as historical, geographical, identification, explanation data may be essentially broadcast to users on a permanent basis. In this way, people may provide information about a landmark or location that other users may find from the location of the landmark.

In embodiments of the present invention, an end-user may use an end-user device 110B to receive the data 100A and the tagged location. As noted previously, a profile associated with the end-user and/or the end-user device 110B and/or a location of the end-user device 110B may be used to filter the data received by the end-user device 110B. In aspects of the present invention, a display 112 may be used to display a virtual representation of locations 115 to the end-user. The virtual representation of locations 115 may be stored on the end-user device 110B, broadcast by the service provider and/or partially stored and partially broadcast. Map functions, street view functions, pictures, electronic representations and/or the like provided by other service providers may be used to generate the virtual representation of locations 115.

In the display the data 100A is displayed tagged to a virtual representation 102B of the real, physical location 102A and/or the virtual representation 102B is a virtual representation of the tagged location.

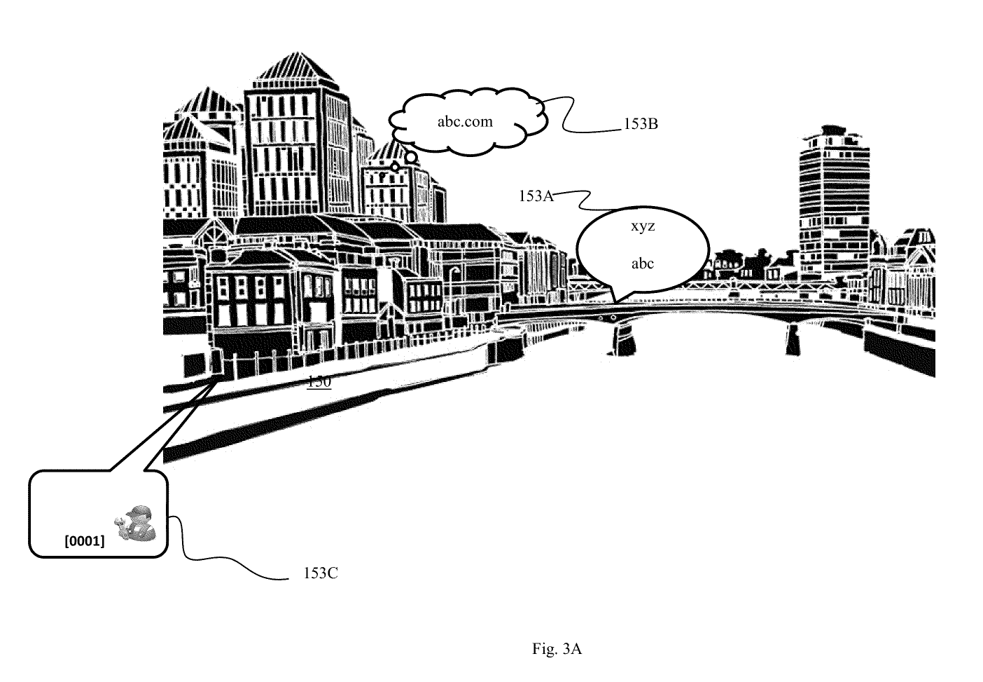

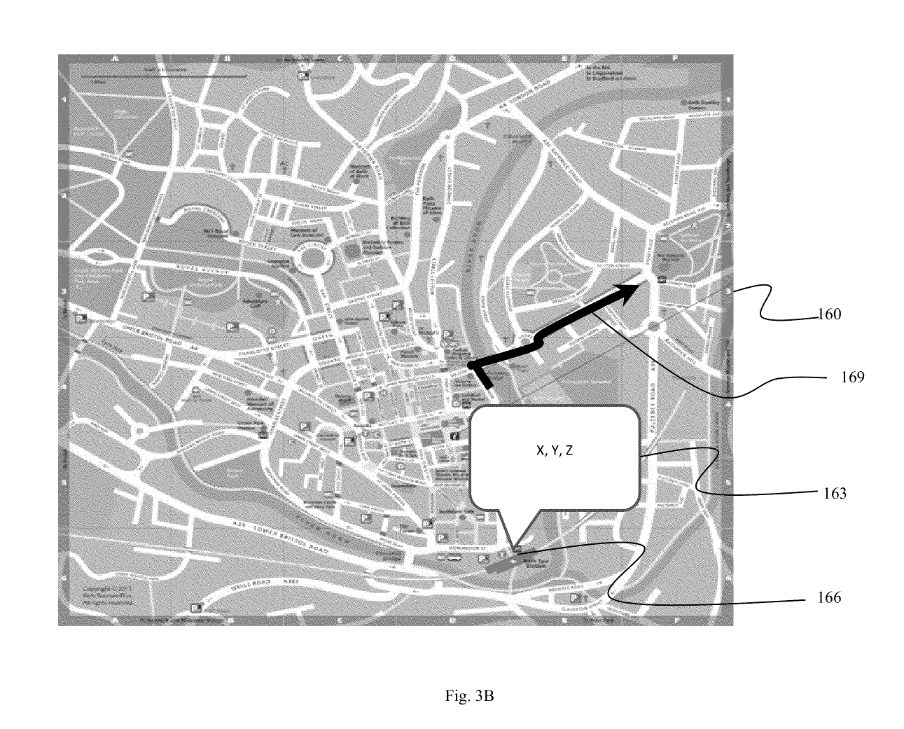

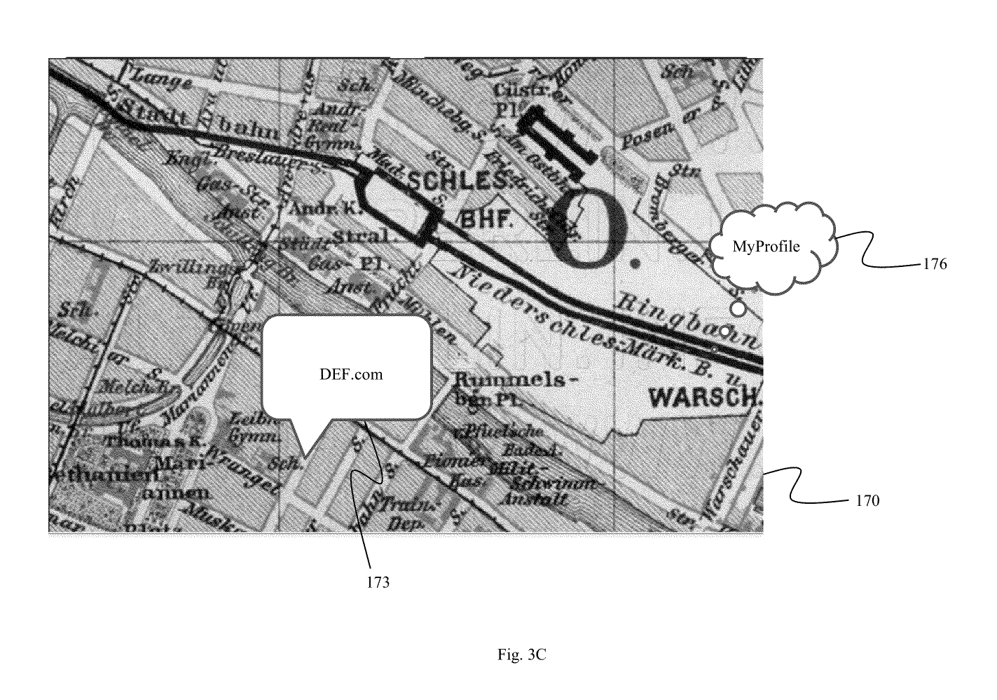

FIG. 3A is an illustration of a virtual horizon of a location based social network, in accordance with an embodiment t of the present invention. In an embodiment of the present invention, a virtual representation of a real location 150 is provided to a user of a location based social network. The virtual representation of a real location 150 may comprise an electronic representation of the real location, a picture of the real location and/or the like. In some embodiments, users of the location based social network may upload electronic representations of locations, landmarks, building or the like for incorporation in the virtual representation of the real location 150. Verification processes may be applied to the user prior to adding the uploaded representation to the virtual representation of the real location 150. In some aspects users of the location based social network may be given reputation attributes and these attributes may determine how and what they may upload, provide on the location based social network.

In FIG. 3A, user data 153A, 153B and 153C is tagged to different locations/features on the virtual representation of the real location 150. In general, GPS location data or the like may provide for accurate identification of the tagged feature location. For indoor locations, network location systems may be required and representations of an internal portion of a building or landmark may be required. In aspects of the present t application, separate displays may be provided for internal locations inside buildings, landmarks or the like and these representations may, for example, be accessed from the virtual representation of a real location 150.

The user data 153A, 153B and 153C may comprise text, videos, pictures, Internet links, hyperlinks, webpage addresses, profiles of a user, avatars, links to a user profile and/or the like. In some aspects, a user may have a location profile with limited information about the user that may be displayed with or linked to the data the user tags on the location based social network.

FIGS. 3B and 3C illustrate virtual map-type representation of locations for a location based social network, in accordance with an embodiment t of the present invention. Map-type virtual representations of real locations may be useful as they are already generated electronically and are easy to search. In FIG. 3B. a map 160 may be used to generate a virtual representation of roads, rivers, buildings and/or other features of real locations. A user may search for data associated with a location by finding the location on the map and accessing data tagged to the location. For example in the figure, data 163 is tagged to a feature/location 166 on the map 160.

A user of a location based social network may find a location by searching through a map or a map may be shown to the user based upon his or her location as provided by a device used by the user or the supplied by the user. The map may be zoomed in or out and tagged data viewed/accessed by the user. The tagged data may be real-time data representing data uploaded by other users establishing facts regarding/occurrences at the location at essentially the time the user is viewing the map. The user may socially interact by uploading a response to the data or providing new data for a location. The user may select a route 169 on the map and obtain data tagged to locations on the route or nearby the route. The tagged data may have a determined lifetime for which it is displayed.

FIG. 3C shows another map-type representation of a location 170 with data 173 and 176 tagged to locations on the map-type representation of the location 170. Filters may be applied to the data based upon settings provided by the user uploading the data, the service provider, a location of the user accessing the data characteristics of the user accessing the data, filters selected by the user accessing the data and/or the like. The user accessing the data may use the data to determine attributes of the location, the person uploading the data and/or the like. A remote person may view the data to determine what is occurring at a location, who is present at a location, properties of a location and/or the like. A person at a location may use the data to discuss occurrences at the location, find out about the location using only location, tag information to a location and/or the like.

While an unimaginable amount of data is available on the Internet and the number of people accessing/using and socializing on the Internet has grown exponentially, social networking, communicating and data storage and retrieval on the Internet is still very often a case of knowing where and how to gather information and/or knowing in the real world the person you are socializing with. To meet/interact with “new” people in the virtual world, Internet users may link to friends-of-friends, broadcast thoughts for others to find and respond to and/or the like. As a result, the storage and retrieval of data on the Internet social communication over the Internet tends to follow pipelines and is not intuitive/consistent with how such things are done in the real world. Moreover, in general, there is a dividing line between the real and virtual worlds that prevents a person from having virtual/real experiences, i.e., the combined experience of both the real and virtual world.

In embodiments of the present invention, location in the real world is used as a parameter for storing data, accessing data, communicating data and/or social networking on the Internet and/or other virtual environment. In such embodiments, the use of real world location information enhances the virtual experience for the user by allowing more realistic social networking, sharing of experiences, data storage/retrieval and more closely combining the real and virtual worlds to increase data meaning and accessibility and allowing for new/enhanced communication of data over the Internet. In short, in embodiments of the present invention, by tagging data/interaction points to real world locations, the data is given meaning, can be communicated based upon location, can be searched using locational searching, each of which provides a new paradigm for using/experiencing the Internet.

In embodiments of the present invention, virtual data storage, virtual data communication/retrieval and/or virtual social interactions are enhanced/transformed by the use of real world location association and/or the like. Embodiments of the present invention allow for virtual socializing in a manner that is consistent with real-world socializing removing the constraints of prior virtual socializing protocols. In some embodiments, users can take part in virtual social experiences/events similar to and/or combined with real world social experiences/events. In aspects of the present invention, an Internet user can locate, retrieve, and communicate data based purely upon real world location.

In one embodiment of the present invention, an Internet user sends a request/data to a service provider to create a virtual interaction point corresponding to a real world location; the requested interaction point is associated with/tagged to the real world location so that another Internet user may find the interaction point using the real world location. The service provider is described in more detail below, but may comprise an Internet service provider the user connects to/communicates with over a network. In some aspects, the service provider may also comprise a network provider.

In one embodiment, the user sends tagging information and data to the service provider. Tagging information may comprise a real world location, a place, business, landmark, coordinates, longitude/latitude, GPS data and/or the like. The service provider tags the data received from the user to a location according to the tagging information. The service provider then publishes/communicates the received data over the Internet and/or other network. The communicated data identifies the interaction point and the tagged real world location to other Internet users. Merely by way of example, in certain aspects other users of the service provider and/or other Internet users may access/view the Interaction point using the real world location. In an embodiment of the present invention, the other Internet users may view a display showing a panorama of real world locations on which the interaction point and/or other interaction points are tagged to locations within the panorama. For example, the Internet users may see a map, virtual representation of a real world location/panorama of real world locations, a picture of a location/panorama of real world locations, video stream of a location/panorama of real world locations and/or the like with data/interaction points tagged thereto.

The data tagged to the real world locations may comprise an avatar, identifying data, a communication, a picture, a video, a link to an Internet site and/or the like. In some aspects, the service provider may provide for displaying of a symbol identifying that tagged data/an interaction point is available at the location and/or may display a linking symbol so a user can link to the data and/or the like. In embodiments of the present invention, in effect a virtual interaction bubble is created that is linked to and displayed/found linked to a real world location. As such, a user may be able to identify that data/an interaction point is tagged to the location and may use the display, which may comprise a touch screen or the like, a mouse, a cursor and/or the like to access the data/interaction point linked to the location. The data/interaction point tagged to the real world location may be referred to herein as a “Mi-Bubble” since in some aspects it comprises a “bubble” of data/an interaction point tagged to a location. A Mi-Bubble describes a data bubble/interaction point tagged to a real world location that is associated with an Internet user. In other aspects, an i-Bubble may be used to refer to data bubble/interaction point tagged to a real world location associated with a venue, landmark and/or the like at a real-world location. For example, a place of business may have an i-Bubble associated with it that may be found, interacted with and/or the like based upon real-world location.

In some embodiments of the present invention, a user may create a Mi-Bubble and tag it to a real world location. The Mi-Bubble may be an identifier for the user, a link to a social network page for the user and/or the like. By tagging the Mi-Bubble to a real world location, location data is provided to other users and/or the Mi-Bubble can be found/interacted with using real world location. The tagging of the Mi-Bubble to a location may be performed automatically by a service provider using locational data for the user associated with the Mi-Bubble that may come from the user's mobile device and/or the network the user uses to communicate to the serviced provider. For example a Mi-Bubble may track on a virtual description of the real world location the movement of the Internet user. In other aspects, the Mi-Bubble may be automatically tagged to a venue, landmark and or the like when the Internet user is at/in the venue, landmark and/or the like. In embodiments of the present invention, users of the service provider may create a Mi-Bubble tagged to a location and/or add data to a Mi-Bubble tagged to a location.

In some embodiments of the present invention, a user may receive from the service provider location data, such as a map, picture, photograph, video stream and/or the like of the user's location, the user's location and the surrounding region (a panorama), a venue where the user is located, a landmark where the user is located and/or the like with data, Mi-Bubbles and/or the liked tagged to the location, surrounding locations, the venue, landmark and/or the like. In some embodiments, the user may use a mobile device and a location of the user may communicated by the mobile device to the service provider and locational data/Mi-Bubbles may be communicated to the user based on the location data communicated by the mobile device to the service provider.

For example, the user may view a display on a mobile device, smartphone, tablet, netbook, laptop and/or the like and see an identifier, showing the users location on a map, virtual representation of the location and/or the like and Mi-Bubbles tagged to the location and/or surrounding locations. In other embodiments, a user may cast-a-net and identify a location, a region, a venue, a landmark and/or the like and view a map/virtual representation of what is mapped with Mi-Bubbles tagged thereto. Merely by way of example, a user may choose a venue, a map location a region of a map and communicate it to the service provider to see Mi-Bubbles tagged to the selected locations. In one embodiment, a user may communicate a route to the service provider and the service provider may communicate Mi-Bubbles tagged to the locations through which the route passes.

In an embodiment of the present invention, the user receiving the Mi-Bubbles may select one of the Mi-Bubbles, such as by touching the displayed Mi-Bubble on a touch screen, placing a cursor on the Mi-Bubble and/or the like. Once selected, the contents of the Mi-Bubble may be displayed, communicated to the user and/or the user may link to data through a link in the Mi-Bubble. In an embodiment of the present invention, the Mi-Bubble may comprise an interaction point and the user may interact with the Mi-Bubble by communicating data to the service provider to be added to the Mi-Bubble.

In this way, the Mi-Bubble may become an interaction point for social communication, data exchange, data communication, data storage and/or the like. Merely by way of example, a user may be at a venue and may wish to engage in social networking. As such, the user may communicate the venue data, such as location of the venue, venue identity, GPS data, locational coordinates/identifying data and/or the like to the service provider along with data for tagging to the location. In n some aspects, the user may select the venue, location, landmark to which data is to be tagged from a display of a virtual representation of the location/panorama provided by the service provider. The service provider may then display the data tagged to the location, i.e., display/communicate a Mi-Bubble that may be found/accessed by other Internet users. Other users may see the Mi-Bubble on a virtual rendition of a location panorama and may interact with the Mi-Bubble and the user who posted the Mi-Bubble. As such, in accordance with an embodiment of the present invention, a first Internet user may create an interaction point tagged to a real world location and other Internet users may interact with the first Internet user in real-time; the other Internet users do not need to know the first internet user and/or may find and/or base the interaction solely on the tagged real world location.

Merely by way of example, a user at a venue such as a coffee shop, club, bar, restaurant, school building, office, hotel and/or the like may wish to tag a communication to the venue. The user may communicate with the service provider and create a Mi-Bubble tagged to the venue. Other users may see the Mi-Bubble tagged to the real world location and communicate with the user through the Mi-Bubble. In other aspects, the user may just want to leave data in the Mi-Bubble and not engage in social networking. Merely by way of example, a user may leave a review of a venue in a Mi-Bubble, may leave a warning about conditions at a location in a Mi-Bubble, and may identify something of interest in a Mi-Bubble and/or the like. The Mi-Bubble data is stored and/or communicated on the basis of the tagged real world location.

Mi-Bubbles may be displayed as a bubble with data viewable by other users in the bubble, such as a textual communication displayed in a bubble. In other aspects, the Mi-Bubble may be displayed as a symbol or the like and the user may need to select the symbol to view the data stored therein. The symbol may communicate information to the user regarding the kind of data associated with the symbol, the age of the symbol (when it was attached to the location/last updated) and/or the like.

The data stored in a Mi-Bubble may be a text communication, a video, a photograph, an audio file, a user address, a link to an Internet location or the like, a social network page for the posting user and/or the like. A mobile user may have a display showing the Mi-Bubbles in the area of the location of the mobile user. In some embodiments of the present invention, there be numerous Mi-Bubbles and a user may select filters to limit the Mi-Bubbles displayed. In other aspects, a user may search, use a search engine, to find Mi-Bubbles of interest. In some embodiments, the service provider may catalogue the Mi-Bubbles and/or the user creating the Mi-Bubble may provide a descriptor for the Mi-Bubble. For example a Mi-Bubble may be catalogued/identified as a social MI-Bubble, a point of interest MI-Bubble, a review/critique Mi-Bubble, an observational Mi-Bubble, a warning/alert Mi-Bubble and/or the like. In other aspects, a user may search M-Bubbles for key words, kinds of content and/or the like.

In some embodiments, an alert may be sent out when a Mi-Bubble is tagged to a location. For example, a user creating the Mi-Bubble may select a group of users to be alerted, may request alerts to be sent to friends or a group of friends of the user, may identify a group of people such as members of a club, school and/or the like to be alerted etc. In some embodiments, an alert may be sent to users within a certain distance of the tagged location, Internet users at the tagged location (which may be a venue, landmark and/or the like) and/or the like.

In some embodiments, the Mi-Bubble may only exist for a discrete period of time. For example, the service provider and/or the user may specify a time-period for which the Mi-Bubble is active. In some embodiments, the Mi-Bubble may no longer be displayed, removed, may be eviscerated and/or the like when the user leaves the tagged location. In other embodiments, the Mi-Bubble may no longer be displayed, removed, eviscerated after a period-of-time. Mi-Bubbles with defined lifetimes, which are destroyed after the user leaves the tagged location and/or the like, may be referred to as fleeting Mi-Bubbles. In embodiments of the present invention, the user may instruct the user to destroy the Mi-Bubble and/or portions of the Mi-Bubble at certain times, upon receipt of an instruction, upon the happening of a specified condition and/or the like.

In some embodiments of the present invention, a user may register a personality page with some details about the user with the service provider or another service provider and the user may include this personality page or a link to the personality page with the Mi-Bubble. In some embodiments, the user may provide social networking data from another provider and/or a link to a social networking page with the Mi-Bubble.

In embodiments of the present invention, an Internet user may be able to view information about other Internet users at a real world location. As such, the person may choose to interact with the Internet users at the location. In some embodiments, an Internet user can view Mi-Bubbles at a location/panorama of locations to obtain real time information about the location. As such in embodiments of the present invention, data may be stored, communicated and/or interactions may take place virtually through virtual interaction points tagged to real-world locations.

In embodiments of the present invention a user may use a fluttering MI-Bubble to communicate thoughts where the thoughts are given locational significance, can be found from the location to which they are tagged and/or the like. In this way, in an embodiment of the present invention a user can store data, find Mi-Bubbles of interest, communicate, socially network and/or the like using real world location. As such, the constraints of existing Internet communication protocols, social networking products, data storage/data retrieval protocols and/or the like may be removed.

In an embodiment of the present invention, the Mi-Bubble may comprise an interaction point tagged to a real location in which users of the service can post communications. For example, in some aspects a user may use a mobile device such as a smart phone, a cellular phone and/or the like to post a communication. The service provider may provide for posting of text based communications, Internet message communications and/or the like in the Mi-Bubble by providing appropriate protocols. In other aspects, links may be set up in the Mi-Bubble to connect video, tablet-to-tablet, smartphone-to-smartphone, cell phone-to-cell phone, and/or the like communication through the Mi-Bubble.

In one embodiment, a user may view a display and see a virtual description of a location using connected Mi-Bubbles. The Mi-Bubbles may be updated regularly, in real-time and/or the like so that the user sees what is going on at the location and/or can interact as things happen at the location. In an embodiment of the present invention, the Mi-Bubbles may provide for combining the virtual world with a real location. For example, a mobile device user may be able to virtually view and virtually interact with other users, the location and/or the like while the mobile user is at the real location. Moreover, in certain embodiments, users may help generate and populate virtual locations with data for the service provider using applications and/or the like. Merely by way of example, Internet users may use applications to add virtual representations of venues, landmarks or the like to the service providers virtual representation of a location, panorama of locations. Similarly, Internet users may add data to Mi-Bubbles/create Mi-Bubbles containing data that are attached to real world locations/virtual representations of real world location. For example, an Internet user could add a virtual representation of a landmark such as a bridge to the virtual representation and/or add a Mi-Bubble to the virtual representation of the bridge with data about the bridge. In other aspects a Mi-Bubble may be tagged to the real world location of a venue such as a church and an Internet user may add data to the Mi-Bubble. In this way, a virtual representation of a location/panorama of locations may be developed with Mi-Bubbles attached to the virtual representation with the Mi-Bubbles containing data for the location. As such, in such aspects, a virtual representation of a real-world location may be created that can be interacted with using only the real-world location. i.e., an Internet user may view the real representation of the real world location/panorama and may view the attached Mi-Bubbles to obtain information.

In some embodiments, adverts and/or the like may be tagged to the Mi-Bubbles and/or the virtual representation of a real world location/panorama. Adverts may provide for discounts to users who purchase goods and provide information about their use of the Mi-Bubble service. In such embodiments, advertisers may generate locational information about purchasers.

In some embodiments of the present invention, a service provider may communicate an i-Bubble to Internet users. An i-Bubble as the term is used herein may comprise a more permanent type of Mi-Bubble and/or may be maintained by a business, organization and/or the like. Unlike a Mi-Bubble that may have a fleeting existence an i-Bubble may be tagged to a location and maintained at the location to provide an interaction point for Internet users. In some embodiments of the present invention, certain contents of the i-Bubble may be refreshed, removed periodically and/or by the i-Bubble owner and/or the service provider.

Merely by way of example, a venue owner may maintain an i-Bubble linked to their venue. Internet users may post data in the i-Bubble for the owner and other users to see. By linking the i-Bubble to a location, embodiments of the present invention provide for locational searching of data. For example a mobile user at a location may see a representation of their location provided by the service provider and may review venues, landmarks and/or the like at their location by viewing the i-Bubbles tagged to/associated with the location. For example, the user may click on an i-Bubble of a venue at their location and find out information about the venue, i.e., the user may use purely locational input/information to search for and retrieve data. As such, a user may see a venue such as a building of interest and may view the display and if there is an i-Bubble attached to the building may ascertain data about the real world location, i.e., what is the building, are there businesses in the building, who is in the building and/or the like.

In an embodiment of the present invention, applications may be provided to Internet users so that they may create an i-Bubble, load data into the i-Bubble or a data storage application linked to or made available through the i-Bubble for a real-world location. In this way, an Internet user may provide data to other users regarding real-world locations. Merely by way of example, a user may identify a virtual representation of real world location on the display and using an application may upload data such as say a piece of history relevant to the location into an i-Bubble tagged to the location. In other aspects, the user may communicate locational identifiers for the location to the service provider for linking the data to in an i-Bubble. In this way, locational wikis may be produced where a user uploads data to an i-Bubble for the location to which the i-Bubble is connected. In this way, data for locations, venues, landmarks may be created, updated, stored and/or the like based upon and retrievable using only location. For example, data may be created, stored and retrieved for a landmark, where the landmark is a real world location, using the landmark's location.

In embodiments of the present invention, owners of a location may have enhanced rights regarding i-Bubbles linked to their location and may put restrictions on data that may be linked. In some embodiments, user of the service provider may have a reputational value assigned to them which may in some aspects be linked to their use of the service provider's service and the value may be linked to permissions for the user with respect to i-Bubble creation and/or use. In other aspects, users of the service provider may be provided with certifications and authentication with respect to themselves and the data they provide though the service provider.

Merely by way of example, where a location is a business, the business owner may tag an i-Bubble to the business. In this way a mobile user may view a display from the service provider see the location, see a virtual representation of the business/venue and/or see the tagged i-Bubble. The business owner may in some aspects provide information in the i-Bubble about the business, advertisements, promotions and/or the like. Moreover, since the i-Bubble may be configured to display communications in a real-time or on a periodically updated schedule, the business owner may communicate directly with Internet users. Moreover, in some embodiments the Internet users may upload communications that may provide data to other Internet users and/or the business owner.

Business owners may in some aspects appoint a concierge to view the i-Bubble so that communications with users of the business and the business may take place virtually. For example, a user who cannot find a product may upload a communication to the business user through the i-Bubble and may receive a reply in the i-Bubble. In some aspects of the present invention, the venue owner may provide docking stations and/or the like from which the users location may be ascertained and/or i-Bubble access may be provided. In aspects of the present invention, a user may have instant/simple access to an i-Bubble tagged to the business by viewing a display on their mobile device from the service provider. In this way, the user may get access to communication, data about a business based purely on location without having to search for the user in the conventional manner and contact the user through found links if such links exist. As such, the i-Bubble system may be simpler and more intuitive for the Internet user then existing protocols.

In some embodiments, the business owner may provide the network for the business location and a mobile user may communicate with an i-Bubble over the business owners network. For example, the business owner may provide a wireless network at the business and the Internet user may interact with an i-Bubble over the wireless network.

In some embodiments of the present invention, a location of the user is communicated to the service provider and a display of the virtual representation of the location and attached Mi-Bubbles and/or i-Bubbles is communicated to the user based on their location. In such embodiments, the display is changed as the user moves in the real world. In some aspects, the user and/or the service provider may set a range/distance for what is displayed to the user on the display. In embodiments of the present invention, by configuring the i-Bubbles as Internet interaction points, data can be communicated through the i-Bubbles in essentially real-time. For example, a business owner may communicate that the business is closed at that particular time, that fish is off the menu, that the wait time is half-an-hour and/or the like. Embodiments of the present invention provide a user to ascertain what is happening at real locations, data about a real location using a locational display.

In some embodiments, advertising for a location may be streamed/provided on the locational display provided to users. In this way, advertisers may, as they do in the real-world, target adverts to people in the location of the products and/or services being promoted. In an embodiment of the present invention, a user may gather data about a location by simply receiving a display from the service provider and viewing the i-Bubbles linked thereto. Furthermore, the user can interact with other users, locations and/or the data stored in the i-Bubble through the i-Bubbles where the interaction may in some aspects be in real-time. In embodiments of the present invention, users may use Mi-Bubble and i-Bubbles to communicate data where the tagging of the data to a real world location provides for/enhances the communication. In embodiments of the present invention, access to the Mi-Bubble, i-Bubble, certain data/communicational functions in the Mi-Bubble/i-Bubble and/or the like may be restricted to Internet users at the location or certain proximity to the location tagged by the Mi-Bubble/i-Bubble.

In some embodiments of the present invention a user may tag an i-Beacon to a location. An i-Beacon may be equivalent to a Mi-Bubble, i-Bubble and/or the like that is configured for a social experience. Merely by way of example, an event may be occurring at a real-world location and an i-Beacon may be tagged to the location to provide a virtual experience corresponding to the real-world event. When the i-Beacon is set up, invites to/alerts may be sent out to Internet users. For example, invites and alerts may be sent out to users of the service providers, a list of people selected by the i-Beacon creator/manager, Internet users at the location or a region around the location that the i-Beacon is tagged to and/or the like. I-Beacons may be set up to provide for user communications, linking/downloading of data from the real-world event such as videos, pictures, photographs audio and/or the like.

I-Beacons may allow for users at the event to upload videos, pictures, photographs audio and/or the like or links to such data to the i-Beacon. In an embodiment of the present invention, an i-Beacon provides an Internet interaction point where a virtual experience corresponding to a real world event may occur. In some aspects of the present invention, data uploaded to the i-Beacon, posted on the i-Beacon may be destroyed when the i-Beacon is removed from the service provider's display. As such, the data shared and communicated is transitory in nature providing some privacy to users. By allowing users to share and communicate data through the i-Beacon a virtual experience may be provided that may correspond to the real-world event at the location to which the i-Beacon is tagged.

In one embodiment of the present invention, an Internet user may create or add data to a Mi-Bubble, i-Bubble, i-Beacon and/or the like and may tag the Mi-Bubble, i-Bubble, i-Beacon and/or the like to a venue, landmark, real-world location and/or the like. For example a guest at a hotel, may tag an Mi-Bubble, i-Bubble, i-Beacon and/or the like to the hotel. In this way the guest may communicate with people at the hotel. In some embodiments, a service provider may only communicate the Mi-Bubble, i-Bubble, i-Beacon and/or the like to people at a tagged real-world location within a certain distance of the tagged real world location. In this way, in the example the hotel guest may create/leave data in a Mi-Bubble, i-Bubble, i-Beacon and/or the like in order to communicate with other guests at the hotel. The guest may place other rules on the Mi-Bubble, i-Bubble, i-Beacon and/or the like so it only communicated to a subsection of the other guests at the hotel. In a similar manner, an owner of the hotel may use a Mi-Bubble, Bubble, i-Beacon and/or the like to communicate in real time messages to guests at the hotel. In the examples herein, data is communicated, interactions are provided without the Internet users having to have knowledge, access or the like to information, communication protocols associated with either the venue (the hotel), the owner of the venue (the hotel) and/or the other guests.

In some embodiments, the interaction point is configured as a bubble in which Internet users can communicate. In some embodiments, the bubble has a finite lifetime so that it disappears along with its contents. As such, the interaction point provides a place where Internet users can communicate and network without leaving fingerprints that can be traced back to the users. In some aspects, an Internet user may arrange for an interaction bubble to be created at a specified time and/or location and invite other users to the Internet interaction bubble. In some aspect interaction bubbles may be tagged to real locations to set up virtual experiences that may be coordinated/combined with real experiences at the tagged location. In other aspects, the bubbles may be tagged to a virtual location, such as an Internet user's social networking home page, a virtual location and/or the like.

In some embodiments of the present invention, docking stations may be provided for users. A docking station may be a real location, a real location with network access, a real location where a mobile device may be docked, a real location in a venue or landmark that is physically identified and/or the like. Docking stations may be used in some embodiments to identify a location of the user. For example, in a venue, a user may send a message to the service provider identifying a docking station where the user is positioned so that the service provider can ascertain a precise location for the user. In some embodiments, non-docking station mobile devices of other users may communicate with, receive signals from a mobile device at a docking station to ascertain the location of the non-docking station mobile device. At landmarks, docking stations may be signposted, identified virtually and/or the like

In one embodiment of the present invention location is used to communicate/receive data from a mobile device. In one aspect the mobile device interacts with a service provider. The term service provider may be used herein to describe a network provider, a service provider, a combination of a network provider and a service provider and/or the like. Mobile devices interact with the Internet via a network, which may be provided by a Wi-Fi network, a cellular communication network (such as a 3G, 4G and/or the like) and/or the like that is often provided by a network provider. Often the mobile user accesses a data provider over the network to obtain desired data, the data provider may be Internet web pages, a search engine, a service providing Internet access to the provided services/data and/or the like and may be free or provided at a charge. Often the network provider will also act as a data provider by providing the mobile user with access to the Internet/web pages, providing services to the mobile user, providing data to the mobile user and/or the like.

In mobile device operation, location information regarding a mobile device may be received/determined by a service provider. For example, global positioning system (“GPS”) data may be communicated between the mobile device and the service provider. For purposes of this patent specification the term GPS means a space-based satellite navigation system, space based satellite positioning system and/or the like. In other aspects, the data provider may be a mobile communication network provider and may determine the location of the device based on network interaction with the mobile device and/or GPS data. Currently, this location data is used to show the user his or her location and to process certain aspects of data provided to the user. In some aspects of the present invention, a combination of GPS data and network interaction with the mobile device may be used to provide location information about the mobile device.

In certain embodiments of the present invention, the service provider may provide data to the mobile device based upon received/determined location information (“LI”). Merely by way of example, the service provider may maintain a database of data concerning real locations and may transmit data concerning the location of the mobile device to the mobile device.

In one embodiment of the present invention, the mobile device may provide user information (“UI”) to the service provider for associating with the (“LI”). The UI may comprise data related to the user of the mobile device or a SIM card, processor, data card and/or the like associated with the mobile device. In certain aspects, the user of the mobile device may select the type and amount of the UI to share with the service provider.

Merely by way of example, in one aspect of the present invention the user may select an identifier, such as for example a photograph, avatar, linguistic descriptor and/or the like for the UI. In such an example, in certain aspects of the present invention, the service provider may associate the UI with the LI for the mobile device user and may make this location-descriptor-data (“LDD”) available to users of the service provider. In such aspects, a user of the service provider may communicate LI and UI to the service provider and the service provider may transmit LDD to other users of the service provider.

For example, the service provider may receive LI and UI information from a one or more mobile devices and may transmit a map, photograph and/or virtual description of a location that includes identifiers (LDD) showing the location and UI of the users on the map, photograph and/or virtual description of the location. In this way, in an embodiment of the present invention, a form of social networking, that is referred to herein as “Facestreet” and “Facestreeting” allows a user of the service provider to obtain location and user information for other users. In some aspects, the map, photograph, virtual description and/or the like or portions of the map, photograph, virtual description and/or the like may be stored on the mobile device to reduce the amount of data exchange between the service provider and the mobile device. In such aspects, the service provider may transmit a pointer and/or portions of the map, photograph, virtual description and/or the like to the mobile device and the mobile device may process this with stored data to provide the Facestreet view to the user.

In one aspect of the present invention, a person may access the service provider, select a location of interest and view UI/LDD for people at that location who are active with respect to the service provider, i.e., where active means the user is interacting with the service provider such that location information for the user is being identified by the service provider. In some embodiments of the present invention, the person accessing the service provider may review the UI/LDD at a location to determine what is happening at a location, what type of people are at a location, who is at a location and/or the like. In some embodiments, the UI may include a link and or the like for allowing a third-party to link from the UI/LDD to further information about the user and/or to communicate with the user.

Merely by way of example, the user may include a web address, email address, phone number, text address, Internet address and/or the like in the UI. In other aspects, a blind link may be provided that when activated may allow/take a third-party to a web page, Internet address and/or the like or may allow the third-party to communicate with the user. Since the link is a blind link, while the third-party may access information and/or communicate with the user, the third-party cannot record the access or communication details. Merely by way of example, the user may allow linking through the user location identifier (“ULI”) to a web page such as a Facebook page or other social media site, to an email address, to a text address, to a network address, to a cell phone number and or the like. In this way, a third-party may be able to obtain information about a user and/or communicate with the user through the ULI.

In embodiments of the present invention, a user of the service provider may be able to view a location descriptor, such as a map, virtual description of the location and/or the like and see ULI's for other users of the service provider. Merely, by way of example a user at a street location may be able to view a virtual representation of the street they are standing on and on their mobile device view ULI's for other users of the service provider or ULI's for people communicating LI and UI information. In certain aspects, if the user sees a ULI of interest they may be able to link through the ULI or an associated link to further data about the person and/or communicate with the person via a communication link in or associated with the ULI.

In embodiments of the present invention, the uses may select security settings for communication of data accessible through the ULI and or communication linking through the ULI. Merely by way of example, the user may select security settings such that only specified people, such as friends, may see information link through the ULI. In other aspects of the present invention, the user may select security settings such that the linking access for the third-party is the same as the linking access selected by the third-party. In some embodiments, the user may select that linking access is only provided to third-parties within a certain distance from the location of the user. In other aspects, the user may set up rules for viewing data or communicating through the ULI where the rules may provide age constraints, members of certain clubs, organizations, schools, companies and/or the like, friends of friends, people registered with the service provider and/or the like.

In one embodiment of the present invention, a user of the service provider may view user information and/or communicate with people at a location. The person does not need to know the people, be friends with people at the location and/or the like. As such, embodiments of the present invention may open up the limited scope of social networking currently available and allow for social interaction based upon location. In this way, embodiments of the present invention may provide a virtual communication process that is consistent with real world communication where people meet and communicate.

In some embodiments of the present invention, ULIs may be combined with location information to provide a real-time overview of locational activity. Merely, by way of example, a person interested in performing an activity at a location, such as going to a bar, attending a course, watching a play, going to a show, watching/playing a sport and/or the like, may use the service provider to view information, ULI/LDD and/or the like about people at the location. Alternatively and/or in addition, the interested person may communicate with a user at the location to find out what is going on, status and/or the like. In some aspects for the present invention, location information may be used to provide that a person can virtually experience an occurrence at a location by viewing user information and/or communicating with one or more users at the location.

For purposes of the present specification the term venue may be used to describe a location where people may meet or gather, such as buildings, theatres, meeting places, arenas, stages, clubs, bars, restaurants, libraries, colleges, schools, places of work, clubs, stadiums and/or the like. For purposes of the present specification the term landmark may be used to describe a location of a natural or man-made feature such as an intersection, street address, park, recreational area, tree, waterfall, monument, bridge and/or the like.

In some aspects of the present invention, location information for a venues may be provided to/by the service provider. In other aspects, venue information may be linked to through the service provider. Venue location information “VLI” may comprise photographs of the venue, video streams from the venue, virtual representations of the venue and/or the like to the service provider. Merely by way of example, where the venue is a building, the venue may provide a virtual representation of the building to the service provider. For example, if the venue is a bar/club, the venue may provide a virtual representation of the bar/club to the service provider and the service provider may associate the virtual representation with a geographical location. The venue may create the virtual representation and upload it to the service provider. In some aspects, the service provider may provide virtual representations of “standard” venues and the venue may select an appropriate one and identify the selection and location to the service provider.

In some aspects of the present invention, location information for a landmark may be provided to/by the service provider. In other aspects, landmark information may be linked to through the service provider. Landmark location information “LLI” may comprise photographs of the landmark, video streams of the landmark, virtual representations of the landmark and/or the like.

In an embodiment of the present invention, the ULI may be associated with the VLI/LLI when the user is at the geographic location of the venue/landmark. For example, when a user is at a bar a third-party may have access to both the ULI and VLI information. In some aspects, the location of the user may be identified with respect to a photograph or virtual representation of the venue. In this way, an actual location of a user in the venue may be provided to users of the service provider. In some aspects, the venue may have a location network, such as Wi-Fi, Bluetooth or the like and the venue network may communicate with the user's mobile device and/or the service provider. In such aspects, location of the user in the building may be identified, determined accurately, motion may be determined and/or the like. This data may be received and/or transmitted by the service provider. Merely by way of example, in an embodiment of the present invention, a third-party may access the service provider and virtually experience the actual events at a venue, such as a bar, club and/or the like. For example, the third-party may view live streams of video from the bar/club, view location information regarding people at the bar/club, communicate with people at the bar/club through a link in the ULI, see information about people at the venue and/or the like.

In some embodiments of the present invention a venue may provide that an event, such as a theatrical show, a musical show and/or the like may be available for locational networking For example, the venue may provide a virtual display of the occurrence/show at the venue on the Internet and allow people not in attendance at the venue to interact with people at the venue using the service provider and ULIs from people at the show. In this way, people at the show may comment on the event, upload pictures, videos and/or the like so that people not at the show can both see the streaming of the show and interact with people at the show.

In some embodiment of the present invention, the venue may provide a virtual experience of the show for people to experience from a mobile device, processor and/or the like. The venue in certain aspects may charge for accessing the virtual show and may even produce virtual seating for people accessing the show. Virtual seating may limit the virtual experience to accessing the ULI of people in a section around the user's virtual seat. For example, with a front row seat, the virtual attendee may access comments, videos, photos, and/or the like from people in the front row. The virtual attendees may also interact over the service provider's network. Thus in aspects of the present invention, it is possible to create a virtual event around an actual event at a venue with social network communication that is similar if not the same as may be experienced by people at the real event.

In one embodiment of the present invention, a virtual bar, club and/or the like may be produced by providing ULI in the bar, club and/or the like. In some aspects, a virtual representation of the bar, club and/or the like may be provided to/by the service provider. The bar, club and/or the like may provide a network such as a wireless, Bluetooth, cellular network and/or the like that may provide for determining locational information with respect to a mobile device user in the bar, club and/or the like. The locational information may be communicated to the service provider so that a locational identifier “LI” for the mobile user may be positioned at a location in the virtual bar, club and/or the like that corresponds to the real location of the mobile user in the real bar, club and/or the like. In such an embodiment, the service provider may communicate the virtual representation of the bar, club and/or the like with LI showing locations of mobile users in the bar, club and/or the like.

In certain embodiments, a mobile user in the bar, club and/or the like may receive the virtual representation of the bar, club and/or the like and the LI's for other mobile users in the bar, club and/or the like and may review information for mobile users in the bar, club and/or the like who have provided such data to the service provider. The mobile user may, where a link is provided by the other mobile user communicate with the other mobile user. Where such communication may be via a social network site, email, cell phone communication, text and/or any other communication protocol that the other mobile user has provided for linking. In an embodiment of the present invention according to the foregoing, mobile users at the bar, club and/or the like may communicate with one another via virtual communication methods without having to know one another previously.

In some embodiments of the present invention, an outside user, such as a person not at the bar, club and/or the like, may access the virtual representation of the bar, club and/or the like and the LI from the service provider and may virtually experience the bar, club and/or the like from a remote location. This experience may involve viewing data, ULI and/or the like, provided by the mobile users at the bar, club and/or the like and/or communicating with people at the bar, club and/or the like via links in the mobile users LI. The bar, club and/or the like may also provide photos, video streams and/or the like to the service provider that the remote user may access to increase the virtual experience.

Venues may have employees, such as bar tenders, entertainers, restaurateurs, and/or the like who may update their ULI and/or update data accessible through a link in the ULI so that people at the venue and/or remote users may obtain updated information regarding what is happening at the venue. For example, information regarding how the employee is feeling, the atmosphere at the venue, the flavour of the food, and/or the like may be updated to provide for a virtual experience of the venue. Also, remote users may network with people at the venue without having to have had any previous interaction and/or knowledge of the person/people they interact with. In other aspects, friends of people at the venue who are remote users can experience being at the venue with their friends using locational information from the service provider.

Remote users may base a decision on whether to go to attend a venue in the real world based upon information accessed through the service provider such as ULI, communications with people at the venue, updated ULI information from employees at the venue and/or the like.

In some aspects of the present invention, the ULI information of mobile users at a venue may only be accessed by people at the venue. In this way, the present invention may provide that social networking is localized to a venue and is not accessible to remote users. In one embodiment of the present invention, a venue, a landmark, a user and/or the like may limit accessibility to ULI or the like. For example, location data, ULI or the like, may only be made available to people at or within a certain proximity of the venue, landmark and/or the location of the user.

In embodiments of the present invention, privacy may be an issue. However, many current mobile devices communicate location information to service providers. In one embodiment of the present invention, the locational services of the service provider are only provided if the user “turns on” the application, i.e., the default is that the service is turned off. In some aspects, warnings regarding the on status of the service may be periodically displayed for the user and/or the service may be turned off if no action/activity is taken by the user. In some embodiments, secure access procedures and/or encryption may be used to provide secure access and use of the service from the service provider. Merely by way of example, the service provider may require registration for the service and may use passwords and/or the like for access to and use of the service.

Registration may require the registration of devices to be used to access the service and cross-correlation between device info, passwords and/or registration information may be used for security. In some aspects, access security may be required to enable the mobile device to communicate/be used to determine location information for the mobile device. As such, a user may be able to turn-of locational interactions between the mobile device and the service provider. In some embodiments, the user may use a removable processor, data card, software storage device and/or the like to maintain the data shared with the service provider. In this way, the user may separate their locational data from the mobile device and/or transfer such data to different devices and/or the service provider may control user access/interaction to the locational service independently of the mobile devices interaction with the network provider.

As discussed previously, current Internet interaction procedures impose constraints on data access and communication. Merely by way of example, social networks do not provide for locational interactions but are generally confined to friendship links or searching interests etc. Moreover, people are often communicating thoughts and ideas out into cyber space, but to find the data and interact with the data dispenser, a person either has to have some knowledge of the dispensing party and/or the subject of their communication.

In an embodiment of the present invention, a user may create a location interaction point (“LIP”). A LIP is a communication that is tagged to a real location. Merely by way of example, in one aspects of the present invention, a user may access location information from a service provider and may tag a communication with a selected location. For example, a user may input, upload a communication to the service provider for tagging with a location. The service provider may then transmit the communication with its location information to other Internet users. As such, a user of the service provider may when viewing the location information for a selected location see the communication. For example a person at a location on a street, in a venue or the like, when viewing location information (such as a virtual representation) for the street, venue and/or the like may see the communication tagged to the street, venue and/or the like. The person may in some aspects of the present invention access the LIP and provide their own communication. In this way, locational conversations may occur between users of the service provider. Such locational conversations may provide for interactions between users and may occur without the sharing of any details of the user such as communication and/or data links.

In some embodiments of the present invention, LIPs may provide for communication of location data. For example, a mobile user stuck in traffic, encountering an accident or the like may create a LIP at their location with traffic information. A person travelling or planning on travelling on the same route may not only view the LIP to obtain information, but may also use the LIP as an interaction point to communicate and receive more data. In certain aspects, this communication at the LIP may be in real-time.

LIPs may provide for locational communication between Internet users. For example, a mobile device user may see something of interest and may create a LIP to communicate this to other people. By linking the data to a location in a LIP, the data is given meaning and relevance to other users. For example, an Internet user can use location as a method to search for data. Merely by way of example, a person intending to go to a landmark or venue or travelling a route can view a map/virtual representation of or covering/including the landmark, venue, route and/or the surroundings and find LIPs. Merely by way of example, a person who experiences a risk, danger, accident and/or the like may create a LIP to communicate the risk.

In some aspects of the present invention, a user may create a location interaction descriptor (“LID”). A LID may comprise information/data about a location that may be tagged to a location for display on a map/virtual representation of the location. For example, a user may want to create a LID tagging their personnel experience/knowledge to a location. In other examples, pictures, photographs videos, descriptions, historical facts and or the like may be provided in a LID. In embodiments of the present invention, locational wilds may be created where information may be provided in one or more LIDs for a location.

In embodiments of the present invention, LIPs and LIDs may change the way data is uploaded, stored and/or communicated on the Internet by providing a locational basis for such uploading/storage and/or communication. Moreover, embodiments of the present invention provide for overlaying of virtual data and communications onto a real world locational underpinning to provide for overlapping real world and virtual world experiences, data communication and/or the like.

In some aspects of the present invention, LIP and/or LID communications may be limited to a certain amount of characters. In certain embodiments of the present invention, LIPs and/or Lids may only be maintained/communicated by the service provider for a defined duration of time. In some, embodiments of the present invention, LIPs and/or LIDs may only be uploaded to the service provider by a user at a location at, proximal to, within a defined distance of the location to which the LIP or LID is to be tagged. In some, embodiments of the present invention, LIPs and/or LIDs may only be only accessible to, communicated to, received by a user at a location at, proximal to, within a defined distance of the location to which the LIP or LID is tagged.

LIPs and/or LIDs may be tagged to a user's location. For example in one embodiment, a user may provide a request to or upload a Lid or a LIP to a service provider and the service provider may tag the LID or LIP to the location of the user. In other, embodiments a user may select a location to which the LIP or the LID is to be tagged. Merely by way of example, a user may send a text message (SMS, MMS, TMS etc.), email, smart phone/tablet messaging/communication protocol, Internet messaging and/or real time communication protocols, interface with a service provider portal and/or the like to the service provider with a request for uploading of the communication as a LIP or a LID. The service provider may then tag the communication to a location and transmit the LIP or the HD to user of the service provider's service.

LIDs and/or LIPs in accordance with an embodiment of the present invention may provide significant improvements/benefits over existing Internet data storage, retrieval and over communication protocols. For example, a venue owner rather than having to update web pages and/or the like may upload a LIP and/or a LIP to provide information about an occurrence at the venue. For example, the venue owner may upload LIPs and/or LIDs detailing promotions, activities, menus etc. and/or the like. Furthermore, the venue owner may provide a LID that is accessible only by people located at the venue to provide information regarding the venue. Similarly, a mobile user at a venue or landmark may provide a LIP with a rule that is only communicated to mobile users at the venue or landmark and/or within a certain distance of the venue or landmark.

Merely by way of example, a person at a hotel may upload a LIP for transmission to mobile users at the hotel. This may provide for social networking, data communication and/or the like. In some embodiments, the user may attach other rules for the LIP so that the LIP is only communicated to friends, members of certain specified groups (such as for example co-workers, club members, students of a certain school/college and/or the like). In this way, a person may communicate with other people using location as the only or one of the only data communication constraints.

In some embodiments of the present invention, the service provider may provide for real-time communication of LIDs and/or LIPs. For example, a mobile user may scan a venue location, for example a restaurant to view recent LIDs and/or LIPs. For example with the restaurant, the mobile user may be able to ascertain a menu for the restaurant and/or reviews of customers in real-time. In one aspect of the present invention, warnings for dangers or facts about emergencies may be transmitted to users of the service provider at the location of the danger or emergency. In such aspects, information and recommended actions may be transmitted to all service provider users at or proximal to a location of danger.

As noted above, locational wikis may be created by users tagging data to real locations. LIDs may comprise information about the location, history of the location, events associated with the location, artistic work associated with the location, pictures of the location, videos of the location, recordings associated with the location, notice of events occurring at the location, timetables for the location and/or the like. In some embodiments, a user may provide a descriptor with the LID and the service provider may store LIDs with the same or associated descriptors together. For example, historical LIDs may be grouped together, events may be grouped together and/or the like. A mobile user may select the type of LIDs of interest, such as for example historical LIDs, and browse through the LIDs. In some aspects, the LIDs may be compiled into a WIKI with a location description and links to related LIDs/data of interest.

In one embodiment of the present invention, the service provider or a party associated with the service provider may provide applications so that data for a location may be uploaded to a virtual representation of the location. For example, in one embodiment, a venue owner may upload a virtual representation of the venue to be included on the service provider's virtual map. In other examples, service provider users may upload virtual representations of landmarks or the like onto the service provider's virtual map. In embodiments of the present invention, a virtual representation of real world locations may be laid out on/coupled with a virtual representation that maps to real world locations. The virtual representations may comprise virtual depictions of the landmarks/venues, pictures, videos and/or the like. In some embodiments, a user may move between views of the virtual representations. For example, a user may view a map to gain an understanding of the location. The user may then switch to a virtual representation of the location to gain more information and/or view pictures and/or photos of the location of interest.

In some embodiments of the present invention, the mobile device may communicate the users location to the service provider and the service provider may automatically transmit location data to the mobile device for display to the mobile user. In some embodiments, the locations data may include LIPs and/or LIDs tagged with the user's location or within a certain distance of the mobile user. In this way, the mobile user may constantly be provided with LIDs and/or LIPs associated with the mobile user's location. In other embodiments, a user of the service provider may select a location, a venue, a landmark and/or the like and the service provider may communicate LIPs and/or LIDs associated with/tagged to the location, venue, landmark and/or the like to the user. In some embodiments, virtual representations of locations, venues, landmarks and/or the like may be communicated to the user and the user may select/click the virtual representations to download/view LIPs and/or LIDs.

In one embodiment of the present invention, the mobile device may be equipped with both a positioning and an orientation system so that the mobile device may be pointed in a direction, the direction and location data sent from the mobile device to the service provider and a virtual representation of the location, venue, landmark and/or the like displayed to the mobile user. In some embodiments, LIPs and or LIDs may also be displayed to the user either by themselves or embedded on the location, venue, landmark and/or the like. In this specification, a mobile device with a positioning and an orientation system may be referred to as an “i”. Using an i, the mobile user may be provided with virtual data for the location he or she is located at and/or viewing. An i may have two screens or a split screen so the mobile user may view the real and virtual world side by side.

As noted above, embodiments of the present invention provide means for virtual displays to be provided at locations, venues, landmarks and/or the like. For example, LIDs at a venue may provide displays to be viewed on mobile devices at different locations in a venue or landmark. In some aspects, the LIDs may be viewed at the same time as real world presentations are viewed. In other aspects, the LIDs may be the complete display at the venue/landmark.

In some embodiments of the present invention, a user may set up a social networking account with the service provider, which may be referred to as a locational social networking site. The user's locational social networking site may have some information about the user, an avatar, pictures, likes, dislikes, photographs, communications with other people and/or the like. In one embodiment, the social networking site may have a link to a further social networking site for the user. The link to the further social networking site may have security/privacy constraints to limit access. The further social networking site of the user may be a separate social networking site provided by the service provider or another provide or may comprise an expanded version of the user's locational social networking site with additional data/information and/or the like. In some embodiments, data posted by a user on the locational social networking site may be deleted after a period of time. Merely by way of example, a rule may be set by the user that unlocked data on the locational social networking site be deleted after a selected period of time. Additionally, copyright protection, anti-copying provisions may be applied to the data stored on and communicated by the locational social networking site. In some embodiments of the present invention, a user may use the locational social networking site and/or a link to their home page on the locational social networking site as their locational information so that when a person clicks on an icon displayed at the location of the user the person is taken to/sees the locational social network homepage of the user.

In some embodiments of the present invention, when a user is at a venue, landmark and/or the like, a message may be automatically sent out electronically to a list of people selected by the user informing them of the user's location. In other embodiments, when a user is at a venue, landmark and/or the like, the user may activate the sending of an electronic message to a list of people selected by the user. In some aspects, the user may have different lists of people and may select between the lists or set up controls so that different lists of people are automatically selected depending on the character/nature of the venue, landmark and/or the like.

In some embodiments of the present invention, the use may create a beacon. A beacon is a social networking interaction point that is tagged to a location. In some aspects, the location may be a virtual location. Merely by way of example, a user may be at a location, such as a venue, landmark and/or the like and may tag an interaction point to the location. When the user tags the interaction location point the service provider may send out a message to a list of people informing them that the interaction point has been set up. The list of people may comprise a list of people created by the user, may be a list of people stored as friends by the user, may be a list of people in a club, firm, school and/or the like associated with the user, may be a rule created set of people (for example the rule may be that the message is sent to all people at the tagged location or within a certain distance of the tagged location, the rule may have multiple aspects such as people within a certain location, people with a certain feature, where the feature may be described on their locational profile, locational social network home page and/or the like).

The interaction point may be configured so that the user and/or people may access the interaction point and enter messages. For example, a display/poster board at the interaction site may allow people accessing the interaction point to post messages and/or carry out conversation. The interaction point may be configured so that the user and/or people may deposit/upload photographs, videos, audio and pictures to the interaction point. For example, a user at a party may set up an interaction point at the party. The user may put a communication, photo, video and/or the like in the interaction point and other people may be sent an electronic message inviting them to view/communicate with the interaction point. As such, a virtual communication point is set up where people may interact and exchange data, communications and/or the like. In aspects where the interaction point is tagged to a real location, the interaction point may serve as a kind of mirror of the real-world event at the location. In some embodiments of the present invention, the beacon is fleeting and the interaction point and its contents are maintained for only a selected duration and the interaction point and the contents thereof are deleted after the selected duration and/or may be deleted by the user. In such embodiments, privacy with respect to the communications and data shared at the interaction point may be maintained.

In some embodiments of the present invention, locational advertising may be performed. For example, when a user has activated his or her locational account so that ULI information or the like is being displayed/communicated by the service provider, the user may receive advertising from an advertiser. In an embodiment of the present invention, an advertiser desiring to communicate advertisements to users in a certain locational region may use the service provider to communicate the advertisements to users when the user is in the locational region. In this way, embodiments of the present invention provide for locationally targeting adverts though the Internet. In certain embodiments, the adverts are only targeted at users who have an active status and have turned-on their locational service with the service provider. In some embodiments, the advertiser may create a beacon that shows an advert at a tagged location that is viewable by the users through a locational service interface.

In an embodiment of the present invention, locational information may be displayed to a user. The locational information may comprise a map, a virtual representation of a location/locational region, for example a virtual representation of venues, landmarks and/or the like at the location/in the locational region/panorama, a combination of a map and a virtual representation and/or the like. Data tagged to the location, portions of the location, landmarks, venues or the like may also be displayed to the user. In some embodiments, locational data such as LUIS, representations/links for other users at the location, beacons, bubbles, data concerning landmarks and/or venues may be displayed to the user. The locational data may be presented separately to the user or in combination with the locational information, i.e., tagged with a map, virtual representation and/or the like. In some embodiments, the user may attach a filter to the information to be provided on the display. For example, the user may put a filter on the data so that only beacons/interaction points/i-bubbles and/or the like with data relevant to the filter are visible for the location. The filter may in some aspects only display only beacons/interaction points/i-bubbles and/or the like where a person posting to/creating the only beacons/interaction points/i-bubbles and/or the like is still at the location of the only beacons/interaction points/i-bubbles and/or the like.

While the principles of the disclosure have been described above in connection with specific apparatuses and methods, it is to be clearly understood that this description is made only by way of example and not as limitation on the scope of the invention.

1. A method for providing virtual interactions, communicating data and/or storing data using a network comprising:
receiving data from a user;
receiving identification of a physical location associated with the data from the user;
tagging the data to a display location, wherein the display location comprises a location at or in a proximity to the physical location; and
making the data available to end-users from the display location.

2. The method of claim 1, wherein the receiving of the data and the location associated with the data and the making the data available to end-users from the display location is performed in essentially real-time.

3. The method of claim 1, wherein the physical location comprises one of a physical location of a device used by the user to generate the data and a physical location selected by the user.

4. The method of claim 1, wherein the making the data available to end-users from the display location comprises tagging the data to a virtual representation of a location comprising the display location.

5. The method of claim 1, wherein the virtual representation is stored on an end-user's device.

6. The method of claim 3, wherein the end-users may access the data by selecting and viewing the virtual representation of the location comprising the display location.

7. The method of claim 1, wherein the making the data available to end-users from the display location comprises restricting access to the data to only the end-users within a defined distance of the physical location or the display location.

8. The method of claim 1, further comprising:
receiving a filter from the user and restricting access to the data to only the end-users meeting criteria in the received filter.

9. The method of claim 1, wherein the filter specifies at least one of the following: membership of a company or organization; presence on a list of friends, age, interests; and membership of another social networking site.

10. The method of claim 1, wherein making the data available to end-users from the display location comprises making the data available to end users from the display location for a limited period of time.

11. The method of claim 3, wherein the virtual representation comprises at least one of a map, an electronic representation and a photograph of the location comprising the display location.

12. The method of claim 1, further comprising
receiving responsive data from a second user;
tagging the responsive data to at least one of the data and the display location; and
making the responsive data available to end-users from the display location.

13. The method of claim 1, further comprising:
characterizing the data; and
using a symbol to identify the character of the data.

14. The method of claim 1, wherein making the data available to end-users from the display location comprises communicating one of a virtual representation of a real-world panorama and a map of a real world area with an interaction point containing the data tagged to the display location therein.

15. A system for communicating location based data, comprising:
a receiver for receiving user data and location data over a network from a user;
a processor configured to tag the user data to a location associated with the location data and make the user data available to end-users from a virtual representation of the location in real-time.
